(19) United States
(12) Patent Application Publication
(10) Pub. No.: US 2019/0257334 A1
(43) Pub. Date: Aug. 22, 2019

(54) SPACER TUBE SUPPORT ASSEMBLY

(71) Applicant: The Babcock & Wilcox Company, Barberton, OH (US)

(72) Inventors: Angela S LIBERATORE, Massillon, OH (US); Joshua D GOODMAN, Stow, OH (US)

(21) Appl. No.: 15/902,280

(22) Filed: Feb. 22, 2018

(51) Int. Cl. F16B 7/00; F16L 3/02; F22B 37/20

(52) U.S. Cl. CPC F16B 7/00; F22B 37/205; F16L 3/02

(57) ABSTRACT

A tube support device is an assembly of a male member and a female member. The male member has a seat section and a prong section. The female member has a seat section and a receiver section having a channel therein. The prong section of the male member slides into the channel in the receiver section of the female member. The device can be made of cast alloy steel. The device can be used in a system for providing lateral and longitudinal alignment support and spacing for tubes, especially at an intersection of a horizontal tube and a vertical tube.

### BACKGROUND

The present disclosure relates to the boiler and superheater arts, particularly a device for providing lateral alignment support for vertical tube sections (e.g., superheater tube sections) and longitudinal alignment support for horizontal tube sections (e.g., spacer tubes).

Conventionally, lateral alignment support for vertical tube sections is provided by U-straps, J-clips, and split ring castings. These devices, however, are unable to carry much lateral load due to the mechanical properties of these devices. Additionally, they are not suitable for use in high temperature/high corrosion environments, making them an undesirable choice for certain applications, such as for supporting superheater tube sections. Tube clamps have also been used, which clamp adjacent tubes to each other. In superheater environments, tubes can expand at different rates from each other, or the clamp may expand at a different rate from the tubes. This results in wear on the tubes, thereby necessitating high maintenance costs or causing tube failure. It would be desirable to avoid such problems.

### BRIEF DESCRIPTION

The present disclosure relates to devices, assemblies, and systems for providing lateral alignment support for vertical tube sections (e.g., superheater tube sections) and longitudinal alignment support for horizontal tube sections (e.g., spacer tubes), and for maintaining spacing between such tubes. Such devices are particularly suitable for use in high temperature environments, such as with superheater tubes in boiler applications.

The devices are desirably capable of withstanding very high gas temperatures (e.g., above 2000° F.), such as in supporting superheater tube sections of a boiler where conventional bilateral support castings will not survive. They permit increased amounts of welding between the device and the tubes, thereby creating a stronger bond and reducing the likelihood of the device being knocked off during vibration. Finally, such devices can be lighter and cheaper to produce than conventional bilateral split ring castings.

Disclosed in various embodiments are tube support devices, comprising: a male member and a female member. The male member has a concave seat section and a prong section, the prong section extending outwardly away from the concave seat section. The female member has a concave seat section and a receiver section, the receiver section extending outwardly away from the concave seat section and having a channel defined therein that is perpendicular to an axis of the concave seat section. The prong section of the male member slides through the channel in the receiver section of the female member.

The concave seat sections of the male member and the female member may each extend through an arc of less than 180°. In particular embodiments, the concave seat sections of the male member and the female member each extend through an arc of about 90° to about 120°.

The prong section of the male member and the channel of the female member may be complementarily shaped. For example, the prong section of the male member may have a trapezoidal shape and the channel in the receiver section of the female member has a complementary shape.

Another alternative way of describing the receiver section of the female member is that it includes first and second projections extending outwardly away from the concave seat section, the channel being defined between the first and second projections, the channel having a base edge adjacent the concave seat section, and the base edge being longer than a distal edge of the channel.

The prong section of the male member may have a base edge adjacent the concave seat section and a distal edge, the prong section being wider at its distal edge than at its base edge.

The device may further comprise a first stop lug and a second stop lug, the first stop lug being joined to a first end of the prong section of the male member, and the second stop lug being joined to a second end of the prong section of the male member. In this construction, the male member cannot be disengaged from the female member.

In other alternative embodiments, the prong section of the male member further comprises a stop surface extending from one side at a first end of the prong section. It is contemplated that such embodiments would only need one stop lug, as the stop surface would serve the function of a second stop lug.

In various embodiments, the concave seat section of the male member defines a lateral axis and the concave seat section of the female member defines a longitudinal axis, the lateral and longitudinal axes extending substantially perpendicular to one another.

The male member and the female member may be made of cast alloy steel.

Also disclosed are systems for providing spacing between a horizontal tube and a vertical tube, the system comprising: a tube support device, comprising: a male member having a concave seat section and a prong section, the prong section extending outwardly away from the concave seat section; and a female member having a concave seat section and a receiver section, the receiver section extending outwardly away from the concave seat section and having a channel defined therein that is perpendicular to an axis of the concave seat section; wherein the prong section of the male member slides through the channel in the receiver section of the female member; wherein the concave seat section of the male member abuts one of the horizontal tube and the vertical tube, and the concave seat section of the female member abuts the other of the horizontal tube and the vertical tube; and wherein the perimeters of the concave seat sections of the male member and the female member are welded to their respective tube.

The male member and the female member of the tube support device should not be welded to one another. The vertical tube may be a superheater tube, and the horizontal tube may be a spacer tube.

Also disclosed are methods for spacing a horizontal tube from a vertical tube, comprising: placing a tube support device between the horizontal tube and the vertical tube, wherein the tube support device is of the structure described herein. A perimeter of the concave seat section of the male member is welded to one of the horizontal tube and the vertical tube, and a perimeter of the concave seat section of the female member is welded to the other of the horizontal tube and the vertical tube.

In some embodiments, the methods further comprise: welding a first stop lug to a first end of the prong section of the male member, and welding a second stop lug to a second end of the prong section of the male member, such that the male member cannot be disengaged from the female member.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 illustrates a perspective view of a first exemplary embodiment of a tube support device according to the present disclosure, showing a male member cooperatively mated with a female member.

FIG. 2A illustrates a side view of the tube support device of FIG. 1 along the axis A100, showing the interlocking mechanism between the male member and the female member. FIG. 2B illustrates a plan view of the tube support device of FIG. 1 along the axis A200.

FIGS. 3A-3E illustrate different views of a first exemplary male member of a tube support device according to the present disclosure. FIG. 3A is a rear perspective view, showing the prong section. FIG. 3B is a side view showing the concave seat section and the prong section. FIG. 3C is a rear view looking at the prong section. FIG. 3D is a top view looking downwards at the concave seat section and the prong section. FIG. 3E illustrates the first exemplary male member with an associated cylindrical tube resting contiguously within the concave seat section of the male member.

FIGS. 4A-4E illustrate different views of a first exemplary female member of a tube support device according to the present disclosure. FIG. 4A is a rear side perspective view, showing the receiver section. FIG. 4B is a plan view showing the concave seat section and the receiver section. FIG. 4C is a side view of the female member, and the channel is visible. FIG. 4D is a front view of only the receiver section. FIG. 4E illustrates the first exemplary female member with an associated cylindrical tube resting contiguously within the concave seat section of the female member.

FIG. 5 is a perspective view showing the tube support device being used in a system. The tube support device laterally supports a horizontal tube and maintains its spacing from a vertical tube.

FIG. 6A is an isometric view of a superheater platen assembly, with a horizontal spacer tube and wrap-around tubes around each platen. FIG. 6B is a side view of the assembly. FIG. 6C is an enlarged view of section 600 of FIG. 6B, showing the tube support device maintaining spacing between the spacer tube and the wrap-around tube.

FIG. 7A is a perspective view of multiple tube support devices according to the present disclosure in use in a system separating a horizontal tube from vertical tubes. FIG. 7B is a side view of the system of FIG. 7A.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

The term “comprising” is used herein as requiring the presence of the named component and allowing the presence of other components. The term “comprising” should be construed to include the term “consisting of”, which allows the presence of only the named component, along with any impurities that might result from the manufacture of the named component.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

The modifier “about” used in connection with a quantity is inclusive of the stated value and has the meaning dictated by the context. When used in the context of a range, the modifier “about” should also be considered as disclosing the range defined by the absolute values of the two endpoints. For example, the range of “from about 2 to about 10” also discloses the range “from 2 to 10.” The term “about” may refer to plus or minus 10% of the indicated number. For example, “about 10%” may indicate a range of 9% to 11%, and “about 1” may mean from 0.9-1.1.

It should be noted that some relative terms are used herein. For example, the terms “upper” and “lower” are relative to each other in location, i.e. an upper component is located at a higher elevation than a lower component in a given orientation, but these terms can change if the device is flipped.

The terms “horizontal” and “vertical” are used to indicate direction relative to an absolute reference, i.e. ground level. However, these terms should not be construed to require structures to be absolutely parallel or absolutely perpendicular to each other. For example, a first vertical structure and a second vertical structure are not necessarily parallel to each other.

The term “perpendicular” is used in its lay sense of two planes that meet at substantially a right angle.

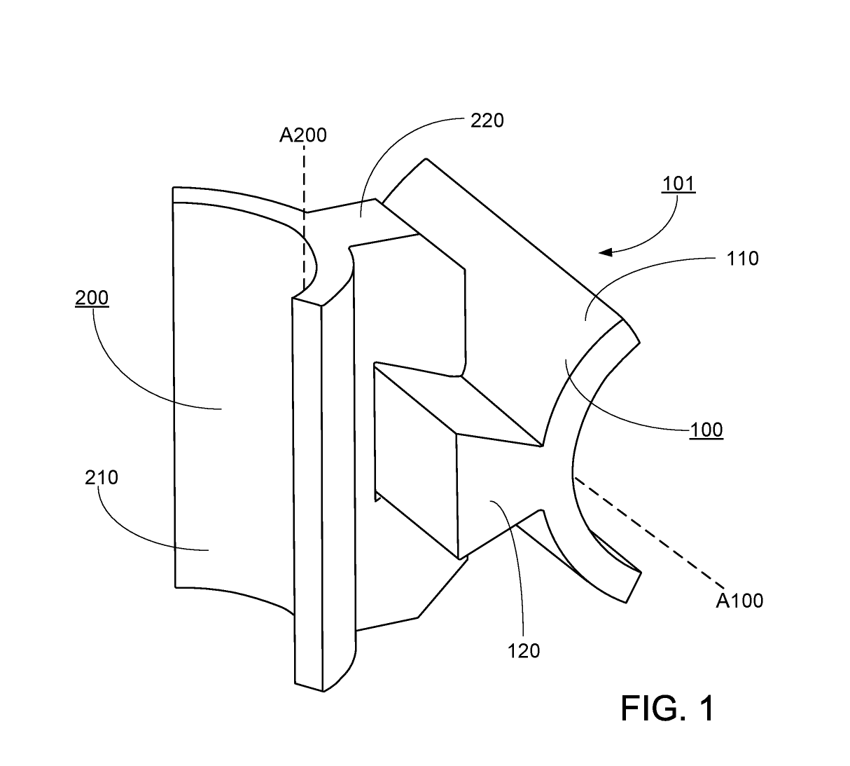

FIG. 1 illustrates a first exemplary embodiment of a tube support device 101. The tube support device 101 is formed from a male member 100 and a female member 200. As seen here, the male member 100 and female member 200 mate with one another by sliding engagement. That is, the male member 100 and female member 200 engage each another by sliding one of the members relative to the other. The male and female members 100, 200 of the tube support device 101 are generally made of a material capable of withstanding very high gas temperatures (e.g., above 2000° F.), such as cast alloy steel.

The male member 100 generally includes a concave seat section 110 and a prong section 120. The seat section 110 is arcuate, and corresponds to a section of a cylindrical sidewall. The prong section extends away from the rear side of the concave seat section. The female member 200 includes a concave seat section 210 and a receiver section 220. The concave seat section 110 of the male member is substantially perpendicular to the concave seat section 210 of the female member. Put another way, the seat section 110 of the male member 100 is oriented along a lateral axis A100, and the seat section 210 of the female member 200 is oriented along a longitudinal axis A200, with the lateral and longitudinal axes A100, A200 extending substantially perpendicular to one another.

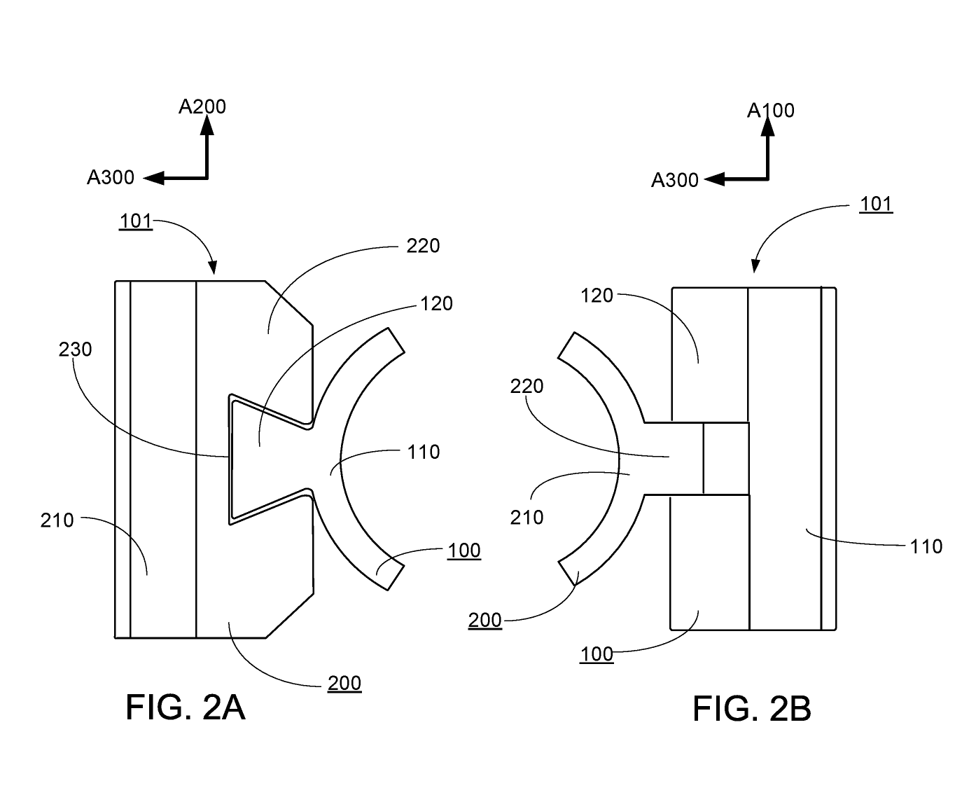

FIG. 2A and FIG. 2B show how the male member 100 and the female member 200 mate with each other. FIG. 2A is a side view along axis A100 of FIG. 1, and FIG. 2B is a plan view along axis A200 of FIG. 1.

Referring first to FIG. 2A, the receiver section 220 of the female member 200 has a channel 230 defined therein. The prong section 120 of the male member 100 slides into the channel 230 along axis A100, thus joining the male member and the female member together. In some particular embodiments, a space of about ⅛″ (one-eighth inch) is present between the prong section 120 of the male member 100 and the channel 230 in the receiver section 220 of the female member 200, to allow for thermal expansion of the two pieces in the direction of a third axis A300, which is perpendicular to both axes A100 and A200. Such expansion might occur due to high temperatures in a boiler or similar environment.

Referring now to FIG. 2B, the male member 100 is disengaged from the female member 200 by sliding the male member 100 along axis A100, such that that the prong section 120 of the male member 100 becomes dislodged from the channel (not visible here) in the receiver section 220 of the female member 200. In particular embodiments, the prong section 120 of the male member 100 and the channel 230 in the receiver section 220 of the female member 200 are shaped so as to prevent the male and female members from being separated by pulling along the axis passing through both concave seat sections 110, 210, i.e. along axis A300. More desirably, the prong section 120 and the channel 230 are complementary in shape. Edges of prong section 120 may be rounded in some embodiments. Edges of receiver section 220 may also be rounded in some embodiments.

It is noted that the male and female members 100, 200 of the tube support device 101 are made as separate pieces, and can move relative to each other. They are not welded to one another, so as to allow some movement between the pieces during thermal expansion.

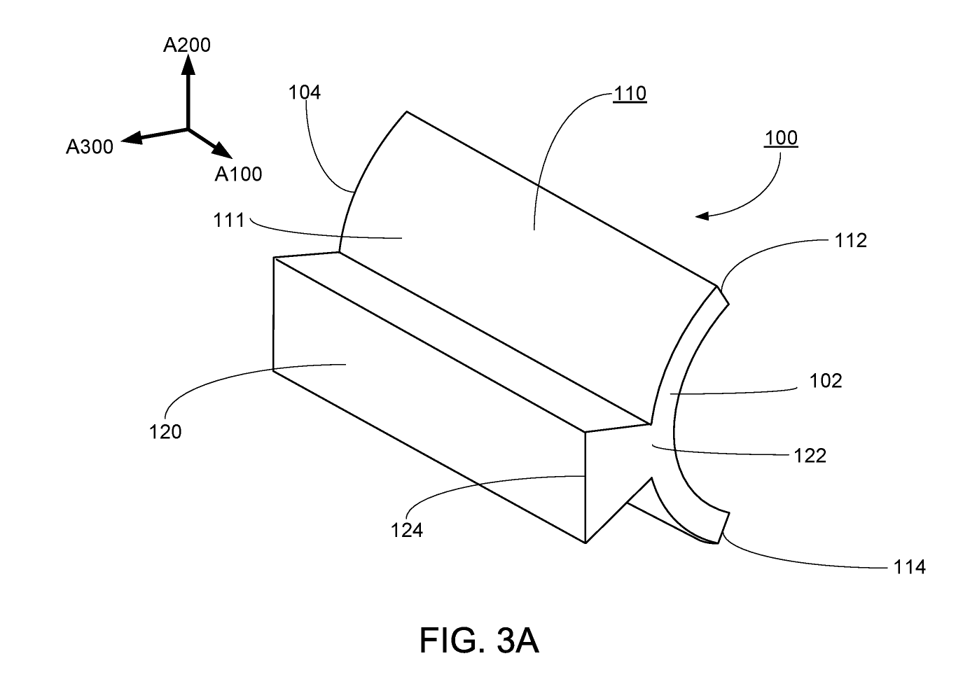

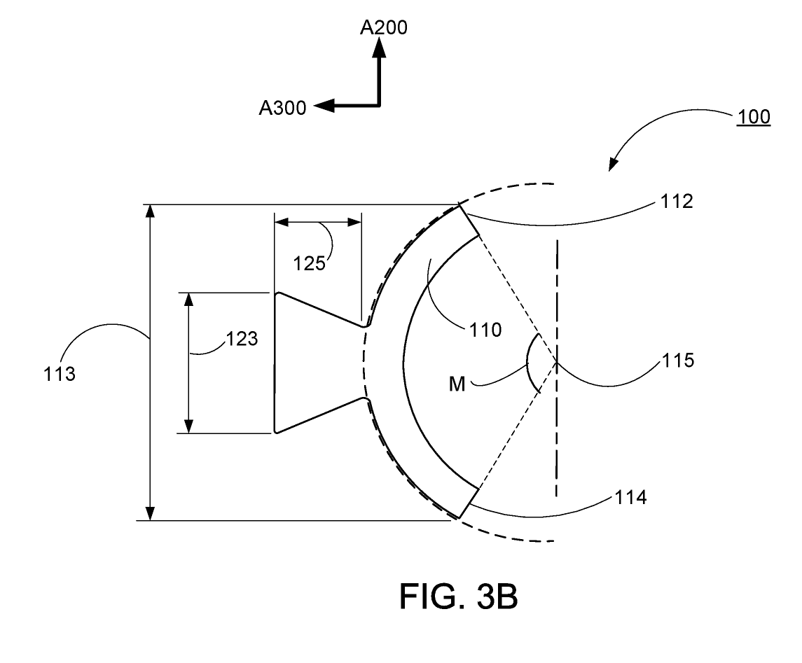

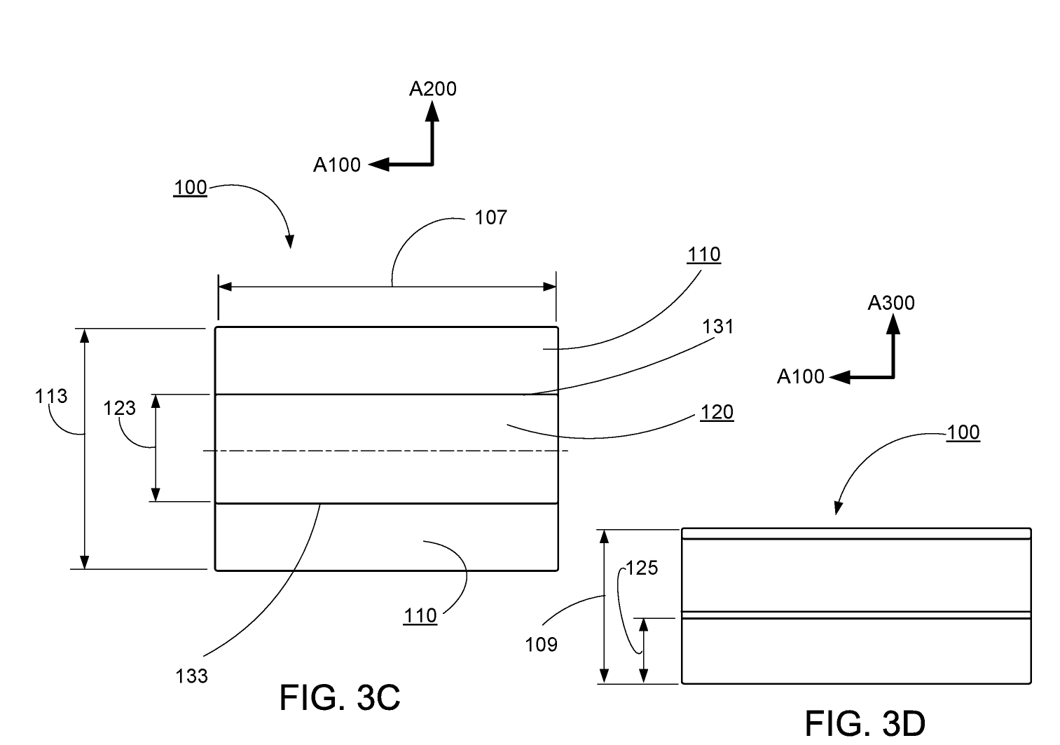

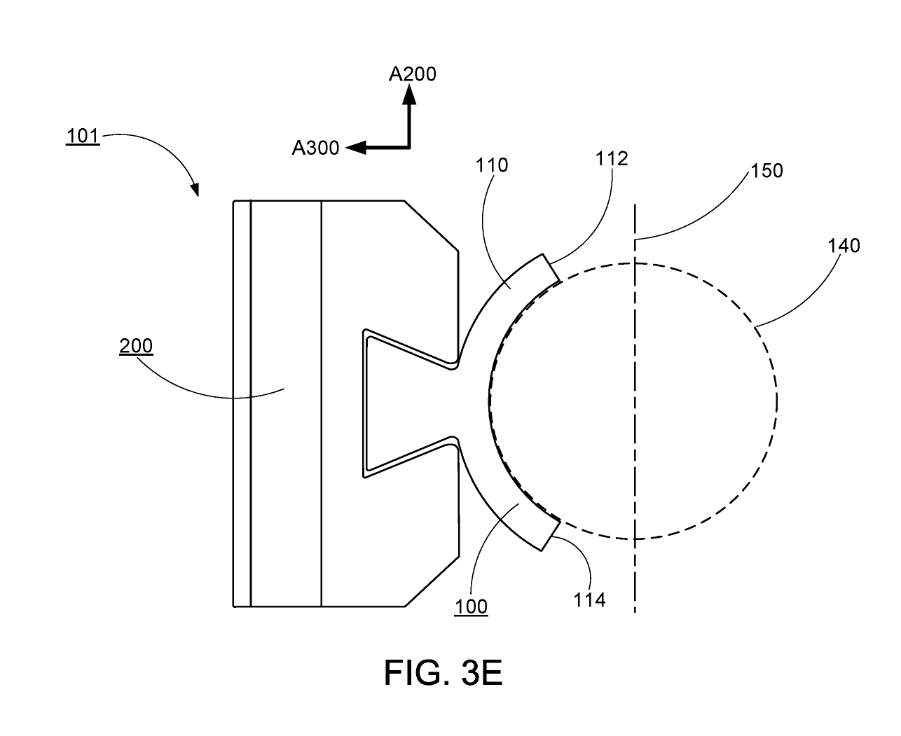

Additional views of the male member 100 are provided in FIGS. 3A-3E. Referring to both FIG. 3A and FIG. 3B, the male member has a first end 102 and a second opposite end 104. The prong section 120 of the male member 100 extends outwardly away from the rear or exterior side 111 of the concave seat section 110. The prong section 120 also extends from the first end 102 to the second end 104, along the length of the concave seat section 110. The concave seat section 110 is in the shape of a partial cylindrical sidewall, and includes a first distal wall 112 and a second distal wall 114 at each end. The concave seat section has an arc M defined by the first distal wall, the second distal wall, and the center of the radius of curvature of the concave seat section (indicated with reference number 115). The arc M is less than 180°, and in more particular embodiments is from about 60° to about 135°, or from about 90° to about 120°.

The prong section 120 extends outwardly from a midpoint of the concave seat section 110 in this embodiment. The prong section 120 in this embodiment has a trapezoidal shape, and is generally solid without any voids within its volume. The prong section 120 has a base edge 122 where the prong section joins the concave seat section 110, and has a distal edge 124 at the opposite end of the prong section. As can be seen in FIG. 3A, the prong section 120 is wider at its distal edge 124 than at its base edge 122, i.e. the distal edge is greater than the base edge. This structure ensures that the male member 100 cannot become disengaged from the female member 200 by a force along axis A300, and that they are separated by sliding along axis A100.

FIG. 3B also indicates some dimensions of the male member 100. The concave seat section has a chord with a width 113. The distal end of the prong section 120 has a width 123, and has a thickness 125. In some exemplary embodiments, the width 113 is about 2.2 inches, the width 123 is about 1 inch, and the thickness 125 is about 0.6 inches.

FIG. 3C is a rear view of the male member 100 along axis A300. Again, the distal end of the prong section 120 has a width 123. The concave seat section 110 has a width 113, and is visible on both sides of the prong section 120. The length of the male member is indicated with reference number 107. Also indicated are opposite sides 131, 133 of the prong section 120. In some exemplary embodiments, the length 107 is about 3 inches.

FIG. 3D is a plan view of the male member 100 along axis A200. The concave seat section 110 and the prong section 120 are indicated. The prong section has a thickness 125, while the male member itself has a thickness 109. In some exemplary embodiments, the thickness 125 is about 0.6 inches and the thickness 109 is about 1.4 inches.

FIG. 3E is a side view of the tube support device 101 along axis A100. The female member 200 is indicated. The concave seat section 110 of the male member 100 is shown, along with distal ends 112 and 114. The concave seat section is designed to be affixed to a tube 140 having a diameter 150 that passes through the center of the tube. The distal ends of the concave seat section 110 do not extend to the diameter 150 of the tube, or put another way, the arc of the concave seat section is less than 180°.

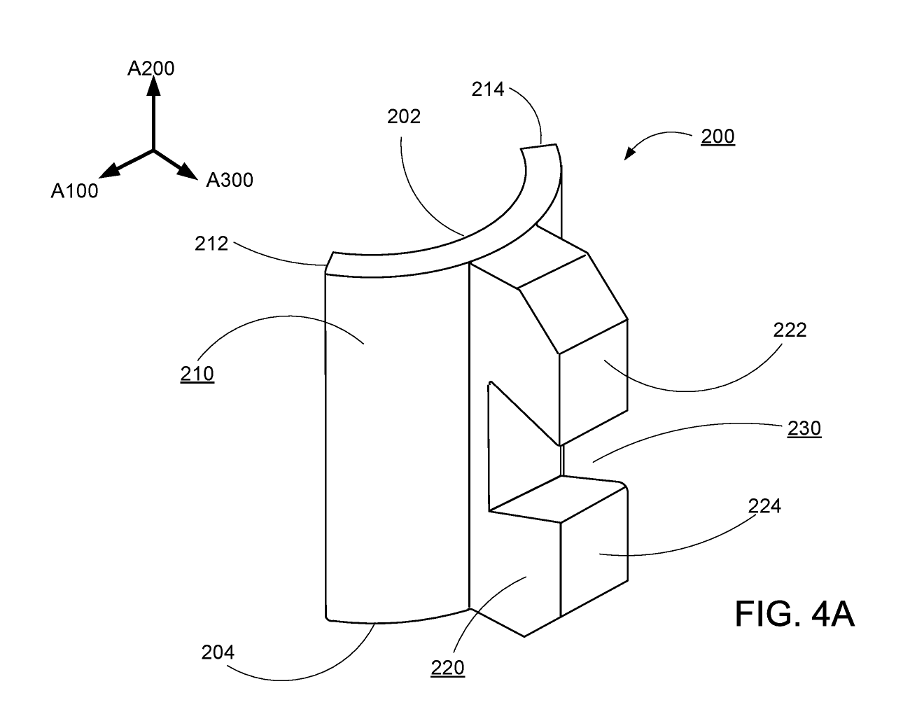

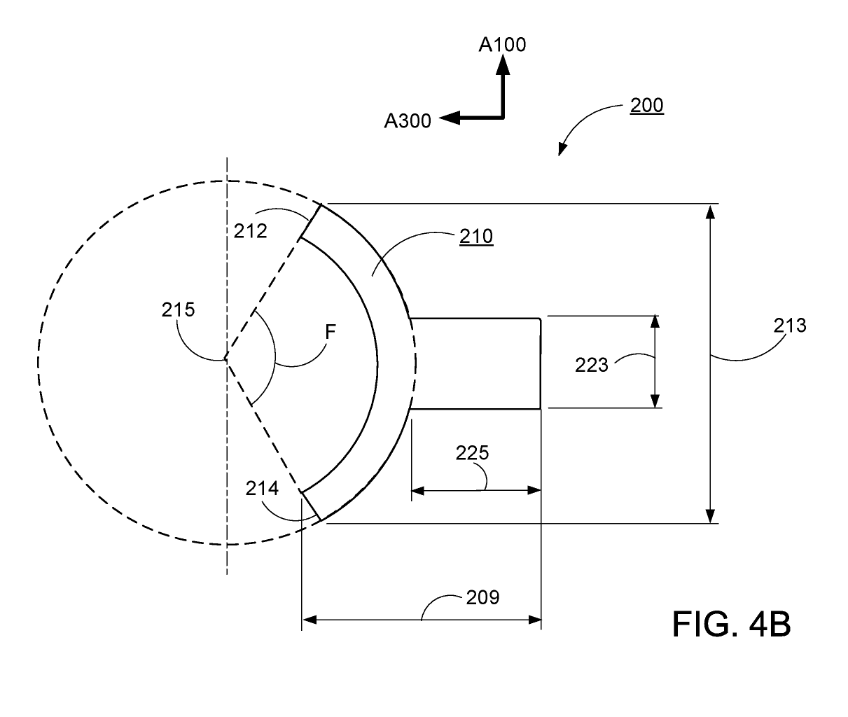

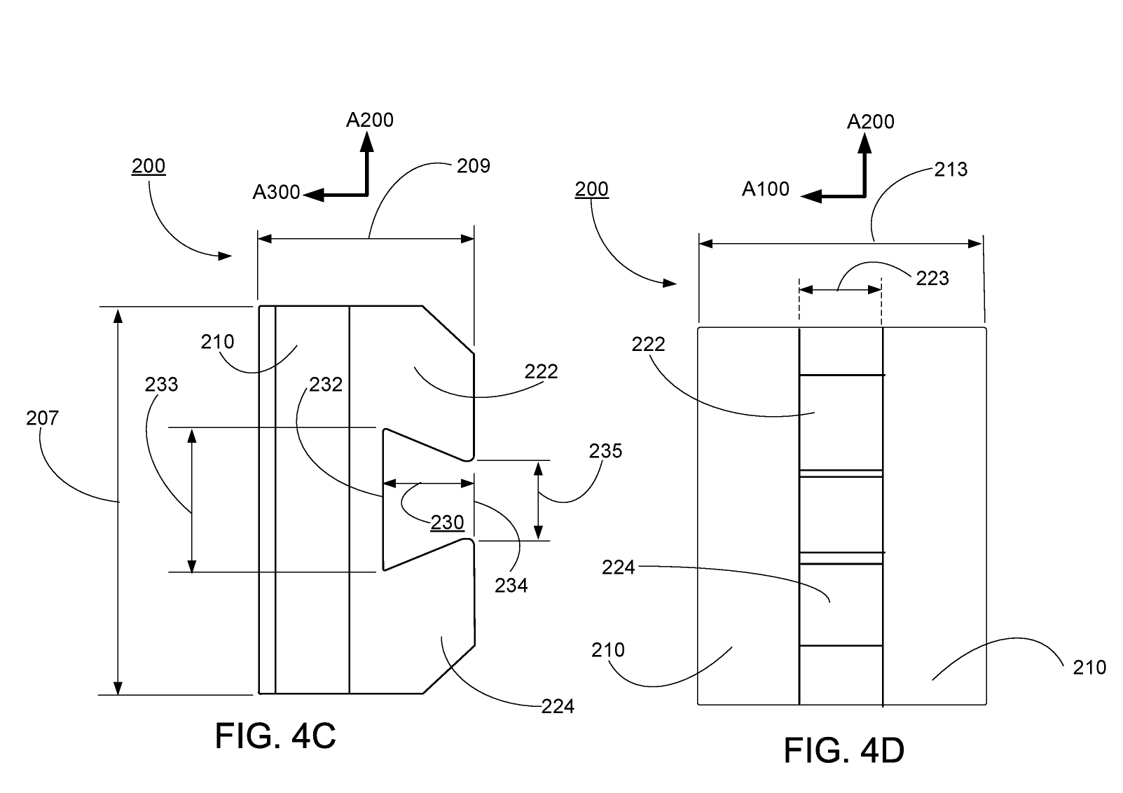

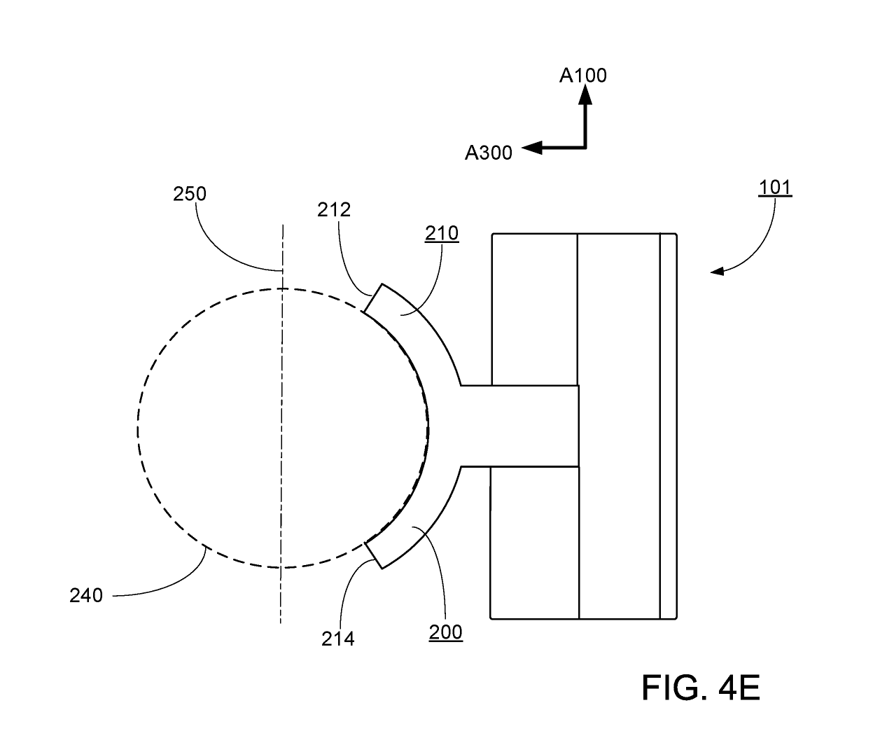

Additional views of the female member 200 are provided in FIGS. 4A-4E. Referring to both FIG. 4A and FIG. 4B, the female member has a first end 202 and a second opposite end 204. The receiver section 220 of the female member 200 extends outwardly away from the concave seat section 210 thereof. The receiver section 220 also extends from the first end 202 to the second end 204, along the length of the concave seat section 210. The concave seat section 210 is in the shape of a partial cylindrical sidewall, and includes a first distal wall 212 and a second distal wall 214 at each end. The concave seat section has an arc F defined by the first distal wall, the second distal wall, and the center of the radius of curvature of the concave seat section (indicated with reference number 215). The arc F is less than 180°, and in more particular embodiments is from about 60° to about 135°, or from about 90° to about 120°.

The receiver section 220 extends outwardly from a midpoint of the concave seat section 210 in this embodiment. The receiver section 220 includes first and second projections 222, 224 which have a channel 230 between them.

FIG. 4B also indicates some dimensions of the female member 200. The concave seat section 210 has a chord with a width 213. The receiver section 220 has a width 223, and has a thickness 225. The female member has an overall thickness 209. In some exemplary embodiments, the width 213 is about 2.2 inches, the width 223 is about 0.6 inches, the thickness 225 is about 0.9 inches, and the thickness 209 is about 1.6 inches.

FIG. 4C is a view of the female member 200 along axis A100. The female member has a length 207 and a thickness 209. The receiver section 220 has a thickness 225. The channel 230 is visible between the projections 222, 224. The channel has a base edge 232 adjacent the concave seat section 210. The (imaginary) distal edge 234 of the channel is on the opposite side of the receiver section. Put another way, the channel 230 in the receiver section 220 of the female member 200 is defined by its base edge 232, its distal edge 234, and opposing side edges from the first and second projections 222, 224. More specifically, the first and second projections 222, 224 taper toward the distal edge 234 of the channel 230. In this way, the channel 230 in the receiver section 220 of this exemplary female member 200 has a trapezoidal shape, which is complementary to the trapezoidal shape of the prong section 120 of the male member 100.

The base edge 232 has a length 233, and the distal edge 234 has a length 235. The channel is wider at the base edge 232 than at the distal edge 234, or in other words the distal edge length 235 is less than the base edge length 233. In some exemplary embodiments, the length 233 is about 1.1 inches, the length 235 is about 0.6 inches, the length 207 is about 3 inches, and the thickness 209 is about 1.6 inches.

FIG. 4D shows a rear view of the female member 200 along axis A300. The width 213 is indicated. The width of the receiver section is also indicated with reference numeral 223. The concave seat section 210 is visible on both sides of the receiver section 220. The two projections 222, 224 and the channel 230 are also indicated here. In some exemplary embodiments, the width 213 is about 2.2 inches, and the width 223 is about 0.6 inches.

FIG. 4E is a plan view of the tube support device 101 along axis A200. The concave seat section 210 of the female member 200 is shown, along with distal ends 212 and 214. The concave seat section is designed to be affixed to a tube 240 having a diameter 250 that passes through the center of the tube. The distal ends of the concave seat section 210 do not extend to the diameter 250 of the tube, or put another way, the arc of the concave seat section is less than 180°.

The male member 100 and the female member 200 may have whatever dimensions are needed so that they can be employed with different tube sizes and for different applications. In particular embodiments, the radius of curvature of the concave seat sections 110, 210 of the male member and the female member are the same, i.e. they are used on tubes having the same diameter. In other particular embodiments, the radius of curvature of the concave seat sections 110, 210 of the male member and the female member are different, i.e. they are used on tubes having different diameters.

As depicted in FIGS. 3A-3E and FIGS. 4A-4E, the concave seat section and the prong section/receiver section of each member have the same length. However, it is contemplated that their length may be different, if desired. For example, the concave seat section may be longer than the prong section/receiver section for each member. This may be desirable in situations where additional perimeter is desired for welding the concave seat section to the tube/pipe that it is supporting.

The two-piece structure of the tube support device provides a distinct advantage over conventional bilateral castings because there is more perimeter for welding the tube support device to the tube compared to conventional castings, which thereby increases thermal contact and creates a stronger bond between the tube and the concave seat section of the tube support device. This reduces the likelihood of the device being knocked off with vibration. This structure further obviates the need for any stop plate to prevent the horizontal tube (e.g., a spacer tube in a superheater tube section) from separating from the tube support device. The tube support devices of the present disclosure are also collectively smaller and lighter (e.g. ˜2 lbs) than conventional bilateral castings (˜7 lbs), thus making the presently-disclosed tube support devices easier, faster, and cheaper to produce without sacrificing, and actually increasing, effectiveness.

It should be understood that while the channel 230 in the receiver section 220 of the exemplary female member 200 and the prong section 120 of the male member 100 depicted herein both have complementary trapezoidal shapes, they may take other forms or geometric shapes. In this regard, the specific shapes set forth in the accompanying drawings are merely representative of exemplary embodiments, and the male and female members can and will take different forms or geometric shapes for different shape tubes and for different applications.

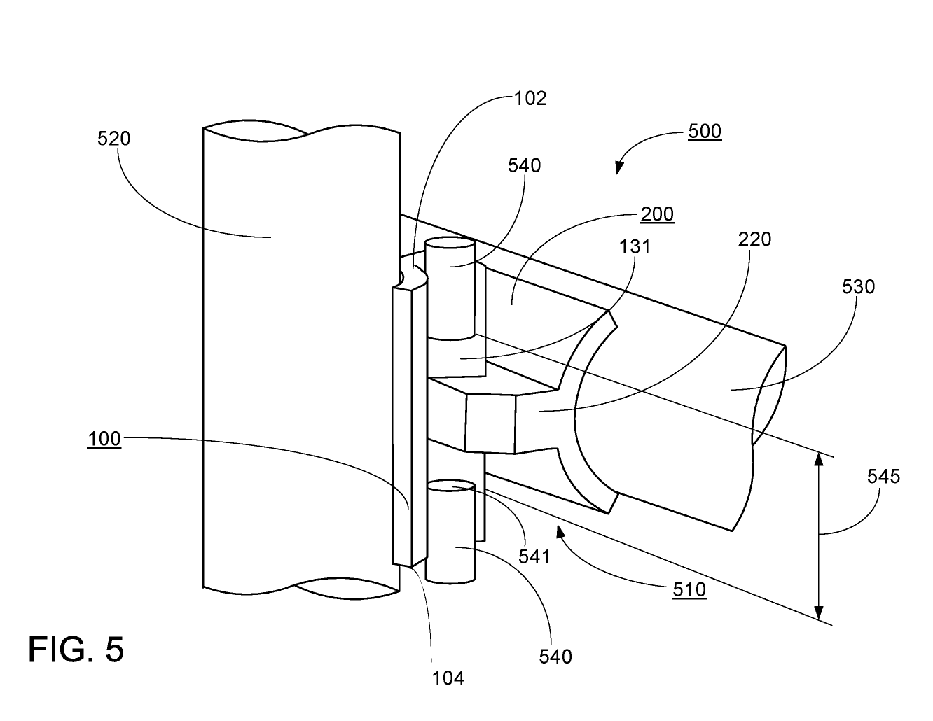

FIG. 5 illustrates a system 500 for providing lateral and longitudinal alignment support for tubes. The system includes a tube support device 510 which is very similar to the tube support device 101 as previously described, having a male member 100 and a female member 200.

In addition to a tube support device 510, the exemplary system 500 includes a vertical tube 520 and a horizontal tube 530. The concave seat section of the male member 100 longitudinal support for the vertical tube 520, and the concave seat section of the female member 200 provides lateral alignment support for the horizontal tube 530. Of course, the locations of the male member 100 and the female member 200 can be reversed if desired.

As further illustrated in FIG. 5, two stop lugs 540 are also depicted. Each stop lug 540 is welded to the prong section of the male member 100, on opposite sides of the receiver section 220 of the female member. Each stop lug provides a stop surface 541, and cooperate so that a travel length 545 is present between them. In use, the stop lugs permit the vertical tube 520 to travel up and down a fixed distance relative to the horizontal tube 530. Generally, stop lugs must be present at both ends, so that the male member cannot slide out of the channel of the female member, keeping the male member and the female member connected together while permitting movement of one of the tubes, (here the vertical tube 520). Such movement may occur, for example, due to thermal expansion. As illustrated here, the two stop lugs 540 are present on the same side 131 of the prong section, but at different ends 102, 104 of the prong section. However, the stop lugs can be on opposite sides of the prong section if desired. Also, more than two stop lugs can be used (e.g. four stop lugs, two lugs on each side of the prong section and at each end of the male member).

The horizontal tube 530 can be welded to the perimeter of the concave seat section of the female member. The vertical tube 520 can be welded to the perimeter of the concave seat section of the male member. Again, this provides a distinct advantage over conventional bilateral castings by increasing thermal contact and creating a stronger bond between the tube support device and the tubes, which reduces the likelihood of the device being knocked off with vibration of the tubes or by thermal impact.

In certain embodiments of the tube support device, the prong section of the male member can be made to include a stop surface that extends from one side of the prong section at a first end of the prong section. This stop surface would serve the same function as one of the stop lugs depicted in FIG. 5. No such stop surface is present at the second end of the prong section or in the center of the prong section, to permit the prong section to be inserted into the channel of the female member. Such embodiments may be envisioned from FIG. 5, where one of the stop lugs 540 is made integral to the male member 100.

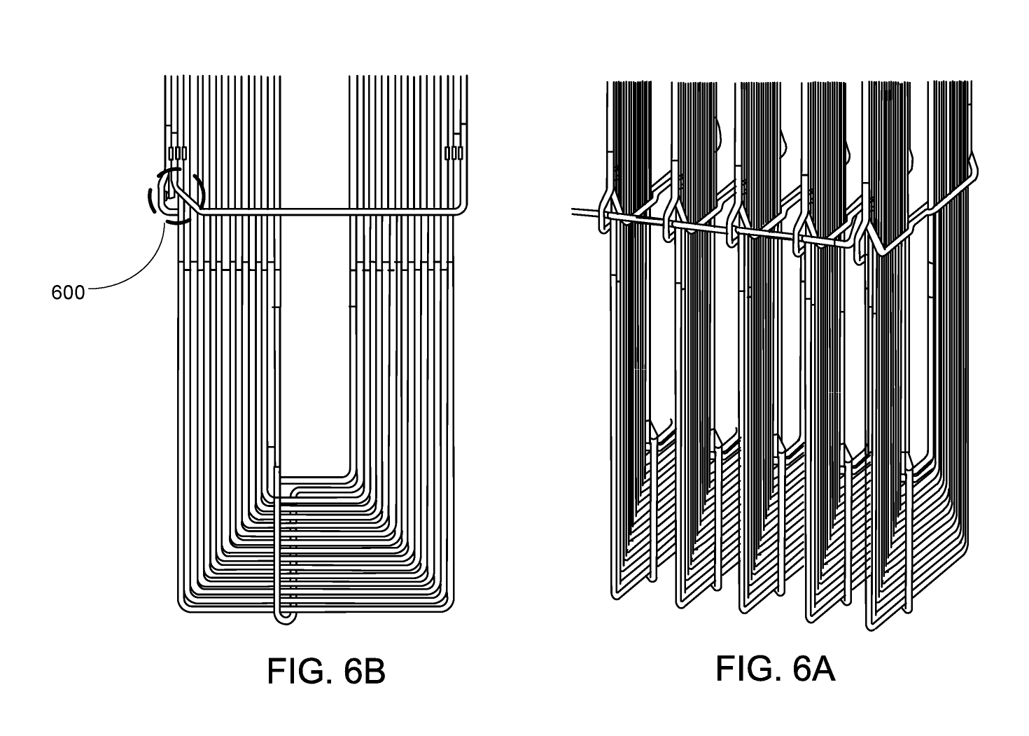

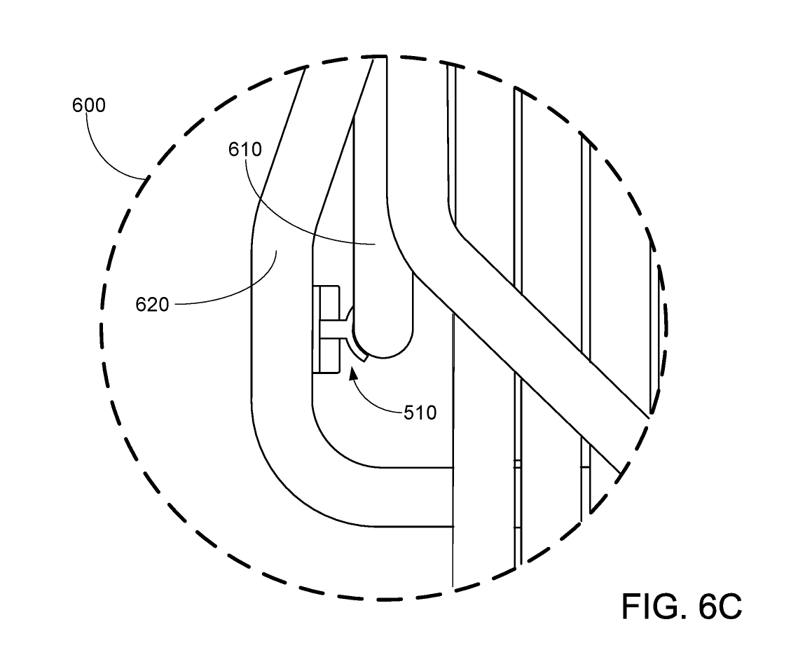

FIG. 6A and FIG. 6B show tube support device 510 in use with a superheater platen assembly. FIG. 6A shows an isometric view of the assembly, and FIG. 6B shows a side view of a single platen. In FIG. 6B, an area 600 is indicated. FIG. 6C shows an enlarged view of section 600 of FIG. 6B. Visible here is tube support device 510, spacer tube 610, and wrap-around tube 620. The spacer tube 610 and the wrap-around tube 620 are perpendicular to each other.

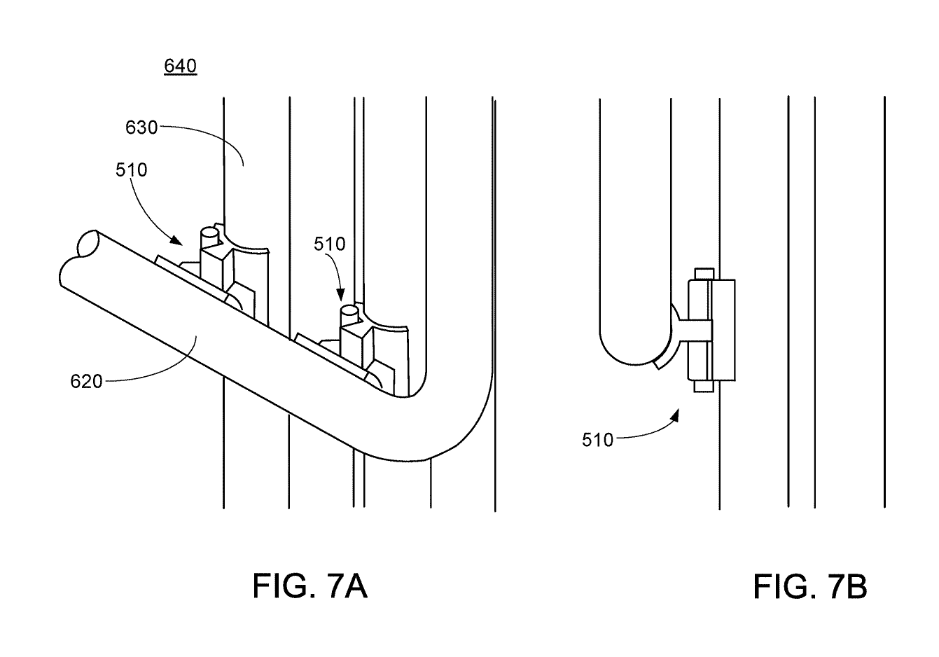

FIG. 7A shows multiple tube support devices 510 serially arranged along spacer tube 610 and against different tubes 630 in a system 640. FIG. 7B is a side view of the view of FIG. 7A.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A tube support device, comprising:
a male member having a concave seat section and a prong section, the prong section extending outwardly away from the concave seat section; and
a female member having a concave seat section and a receiver section, the receiver section extending outwardly away from the concave seat section and having a channel defined therein that is perpendicular to an axis of the concave seat section;
wherein the prong section of the male member slides through the channel in the receiver section of the female member.

2. The device of claim 1, wherein the concave seat sections of the male member and the female member each extend through an arc of less than 180°.

3. The device of claim 2, wherein the concave seat sections of the male member and the female member each extend through an arc of about 90° to about 120°.

4. The device of claim 1, wherein the prong section of the male member and the channel of the female member are complementarily shaped.

5. The device of claim 1, wherein the prong section of the male member has a trapezoidal shape and the channel in the receiver section of the female member has a complementary shape.

6. The device of claim 1, wherein the receiver section of the female member includes first and second projections extending outwardly away from the concave seat section, the channel being defined between the first and second projections, the channel having a base edge adjacent the concave seat section, and the base edge being longer than a distal edge of the channel.

7. The device of claim 1, wherein the prong section of the male member has a base edge adjacent the concave seat section and a distal edge, the prong section being wider at its distal edge than at its base edge.

8. The device of claim 1, further comprising a first stop lug and a second stop lug, the first stop lug being joined to a first end of the prong section of the male member, and the second stop lug being joined to a second end of the prong section of the male member, such that the male member cannot be disengaged from the female member.

9. The device of claim 1, wherein the prong section of the male member further comprises a stop surface extending from one side at a first end of the prong section.

10. The device of claim 1, wherein the concave seat section of the male member defines a lateral axis and the concave seat section of the female member defines a longitudinal axis, the lateral and longitudinal axes extending substantially perpendicular to one another.

11. The device of claim 1, wherein the male member and the female member are made of cast alloy steel.

12. A system for providing spacing between a horizontal tube and a vertical tube, the system comprising:
a tube support device, comprising:
a male member having a concave seat section and a prong section, the prong section extending outwardly away from the concave seat section; and
a female member having a concave seat section and a receiver section, the receiver section extending outwardly away from the concave seat section and having a channel defined therein that is perpendicular to an axis of the concave seat section;
wherein the prong section of the male member slides through the channel in the receiver section of the female member;
wherein the concave seat section of the male member abuts one of the horizontal tube and the vertical tube, and the concave seat section of the female member abuts the other of the horizontal tube and the vertical tube; and
wherein the perimeters of the concave seat sections of the male member and the female member are welded to their respective tube.

13. The system of claim 12, wherein the concave seat sections of the male member and the female member each extend through an arc of less than 180°.

14. The system of claim 12, wherein the male member and the female member of the tube support device are not welded to one another.

15. The system of claim 12, wherein the tube support device further comprises a first stop lug and a second stop lug, the first stop lug being joined to a first end of the prong section of the male member, and the second stop lug being joined to a second end of the prong section of the male member, such that the male member cannot be disengaged from the female member.

16. The system of claim 12, wherein the prong section of the male member further comprises a stop surface extending from one side of the prong section at one end of the male member, and the tube support device further comprises a stop lug that is joined to an opposite end of the prong section the male member, such that the male member cannot be disengaged from the female member.

17. The system of claim 12, wherein the vertical tube is a superheater tube, and the horizontal tube is a spacer tube.

18. A method for spacing a horizontal tube from a vertical tube, comprising:
placing a tube support device between the horizontal tube and the vertical tube, wherein the tube support device comprises:
a male member having a concave seat section and a prong section, the prong section extending outwardly away from the concave seat section; and
a female member having a concave seat section and a receiver section, the receiver section extending outwardly away from the concave seat section and having a channel defined therein that is perpendicular to an axis of the concave seat section;
wherein the prong section of the male member slides through the channel in the receiver section of the female member;
welding a perimeter of the concave seat section of the male member to one of the horizontal tube and the vertical tube, and
welding a perimeter of the concave seat section of the female member to the other of the horizontal tube and the vertical tube.

19. The method of claim 18, further comprising:
welding a first stop lug to a first end of the prong section of the male member, and
welding a second stop lug to a second end of the prong section of the male member, such that the male member cannot be disengaged from the female member.

20. The method of claim 18, wherein the prong section of the male member and the channel of the female member are complementarily shaped.
